(19) United States
(12) Patent Application Publication
(10) Pub. No.: US 2021/0113008 A1
(43) Pub. Date: Apr. 22, 2021

(54) Pressure Cooker Having Pressure Release Mechanism

(71) Applicant: Hamilton Beach Brands, Inc., Glen Allen, VA (US)

(72) Inventors: Tiffany Luce, Sandston, VA (US); George W Stamper, III, Quinton, VA (US); Alexander D Raring, Midlothian, VA (US)

(21) Appl. No.: 16/655,322

(22) Filed: Oct. 17, 2019

(51) Int. Cl. A47J 27/092; A47J 27/08; F16K 17/06

(52) U.S. Cl. CPC A47J 27/092; F16K 17/06; A47J 27/0802

(57) ABSTRACT

A pressure cooker includes: a base and a lid, wherein the lid includes a mechanical pressure release mechanism. Upon the activation of a solenoid within the base of the pressure cooker, the pressure release mechanism is configured to lift a valve cover, so as to allow steam to be released from an interior chamber of the cooker. Upon deactivation of the solenoid, the pressure release mechanism is configured to return in an initial resting condition, with the valve cover resealing the interior chamber of the cooker.

### FIELD OF THE INVENTION

This invention relates generally to pressure cookers and, more particularly, to mechanism for releasing pressure from a pressure cooker via a user control input or automatically at the end of a cooking cycle.

### BACKGROUND

Pressure cookers operate by cooking foodstuff under pressure, which accelerates the cooking process. In order to cook under pressure, pressure cookers heat a sealed internal chamber containing the food causing the existing gas to expand. Expanding pressure in a sealed chamber increases pressure and there is no need to pump additional gas into the vessel.

After the pressure cooker has finished cooking food, those cookers known in the art commonly allow release of the internal pressure in three different ways. First, pressure cookers may utilize a “natural release,” in which the vessel is allowed to gradually cool down, thereby allowing the gas inside to contract until the pressure subsides. This can occur as the high pressure gas escapes through gaskets to ambient conditions. However, natural release may have several drawbacks. A user cannot open the pressure cooker while the chamber is pressurized beyond a threshold amount. Therefore, due to the amount of additional time that food remains in the pressure cooker during natural release, some food may end up overcooked. It can also be unclear to the user when the appliance is able to be opened

As an alternative to natural release, pressure cookers may allow for a “quick release” option. A quick release typically involves manually opening a vent on the cooker to allow pressurized gases to quickly escape from the internal chamber. The gas is heated would almost always contain vaporized fluid (steam). The quick release option may also have several drawbacks. For instance, for some foods, such as pasta or soup, rapid release of gas may cause the liquid within the chamber to begin to foam, which may overflow through the vent pipe and cause spillage and can soil the release valve for future operation. A user has to exhibit caution when using a manual release valve as well due to the release of high temperature gas. Therefore, it may be desirable for a pressure cooker to allow users to select whether to use a natural or quick release depending on the nature of the recipe being used and on what foods are being cooked.

Third, some pressure cookers may also use a combination of the natural and quick release, allowing gas to escape from the internal chamber of the cooker at intermittent intervals.

Many pressure cookers known in the prior art require the user to monitor the cooker in order to either turn off the heat or release the gas when the user wants the cooking to stop, depending on which release method is being used. However, requiring users to actively monitor the cooker may be inconvenient, as it may prevent users from performing other tasks while the cooking is occurring and may increase the risk of overcooking the food due to forgetfulness or accidents of planning on the part of the users.

Therefore, a pressure cooker which provides users with flexibility in automatically or remotely (i.e., not manually) releasing pressure from the cooking vessel may be desirable.

### SUMMARY

As a first aspect, embodiments of the invention are directed to a pressure cooker. The pressure cooker comprises: a base configured to provide heat to a chamber for pressure cooking; a lid that engages the base to seal the chamber; a valve in the lid configured to selectively release pressure in the chamber through the lid; a pressure release mechanism mounted to the lid and configured to engage the valve, the pressure release mechanism configured to move between resting and release positions, wherein in the resting position the valve remains in a sealed condition, and in the release position the pressure release mechanism engages the valve to unseal the valve from the lid to enable pressure in the chamber to be released through the lid; and a solenoid operatively associated with the pressure release mechanism to move the pressure release mechanism from the resting position to the release position. There is no electrical connection between the base and lid.

As a second aspect, embodiments of the invention are directed to a pressure cooker, comprising: a base configured to provide heat to a chamber for pressure cooking; a lid that engages the base to seal the chamber; a valve in the lid configured to selectively release pressure in the chamber through the lid; a pressure release mechanism mounted to the lid and configured to engage the valve, the pressure release mechanism configured to move between resting and release positions, wherein in the resting position the valve remains in a sealed condition, and in the release position the pressure release mechanism engages the valve to unseal the valve from the lid to enable pressure in the chamber to be released through the lid; and a force generator operatively associated with the pressure release mechanism to move the pressure release mechanism from the resting position to the release position. The pressure release mechanism includes a lifting member residing within the lid, the lifting member including a lifting finger that engages the valve to unseal the valve as the pressure release mechanism moves from the resting position to the release position.

As a third aspect, embodiments of the invention are directed to a pressure cooker, comprising: a base configured to provide heat to a chamber for pressure cooking; a lid that engages the base to seal the chamber; a valve in the lid configured to selectively release pressure in the chamber through the lid; and a pressure release mechanism mounted to the lid and configured to engage the valve, the pressure release mechanism configured to move between resting and release positions, wherein in the resting position the valve remains in a sealed condition, and in the release position the pressure release mechanism engages the valve to unseal the valve from the lid to enable pressure in the chamber to be released through the lid. The pressure release mechanism includes: a lifting member pivotally attached to the lid, the lifting member including a lifting finger that engages the valve to unseal the valve; a toggle member pivotally attached to the lid and engaging the lifting member; and a piston operatively connected with the toggle member. The pressure cooker further comprises a force generator operatively associated with the piston to move the piston upwardly to move the pressure release mechanism from the resting position to the release position.

### BRIEF DESCRIPTION OF THE FIGURES

FIG. 1 is a top perspective view of a pressure cooker, according to an embodiment of the invention.

FIG. 2 is a top view of the pressure cooker of FIG. 1.

FIG. 3 is a sectional view of the pressure cooker of FIG. 1.

FIG. 4 is an enlarged sectional view of a portion A of FIG. 3, showing a pressure release mechanism within a lid of the pressure cooker.

FIG. 5 is a bottom perspective view of the pressure release mechanism of FIG. 4 separated from the lid of a pressure cooker.

FIG. 6 is a top partial cutaway view of the pressure release mechanism of FIG. 4.

FIG. 7A is a sectional view of the pressure cooker of FIG. 1, showing the pressure release mechanism of FIG. 4 in an initial resting position.

FIG. 7B is a sectional view of the pressure cooker of FIG. 1, showing the pressure release mechanism of FIG. 4 in a release position.

FIG. 8A is a partial sectional view of a release mechanism according to alternative embodiments of the invention shown in the resting position.

FIG. 8B is an enlarged partial sectional view of the release mechanism of FIG. 8A shown in the release position.

FIG. 9 is a sectional view of a pressure cooker, according to another embodiment of the invention.

### DETAILED DESCRIPTION

The present invention is described with reference to the accompanying drawings, in which certain embodiments of the invention are shown. This invention may, however, be embodied in many different forms and should not be construed as limited to the embodiments that are pictured and described herein; rather, these embodiments are provided so that this disclosure will be thorough and complete, and will fully convey the scope of the invention to those skilled in the art. It will also be appreciated that the embodiments disclosed herein can be combined in any way and/or combination to provide many additional embodiments.

Like numbers refer to like elements throughout. In the figures, certain layers, components or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all technical and scientific terms that are used in this disclosure have the same meaning as commonly understood by one of ordinary skill in the art to which this invention belongs. The terminology used in the below description is for the purpose of describing particular embodiments only and is not intended to be limiting of the invention. As used in this disclosure, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “on,” “attached to,” “connected to,” “coupled with,” “contacting,” etc., another element, it can be directly on, attached to connected to, coupled with or contacting the other element or intervening elements may also be present. In contrast, when an element is referred to as being, for example, “directly on,” “directly attached to,” “directly connected to,” “directly coupled with,” or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “above”, “over”, “upper”, “lower”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

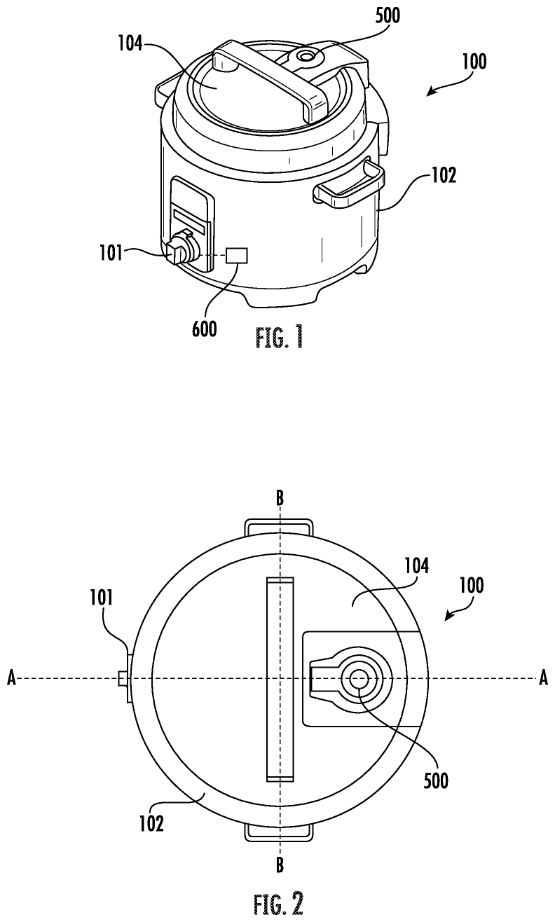

Referring now to the drawings, a pressure cooker, designated broadly at 100, is shown in FIGS. 1-7B. The pressure cooker 100 comprises a base 102, a lid 104, and a valve cover 500 on the lid 104. These components are described in greater detail below.

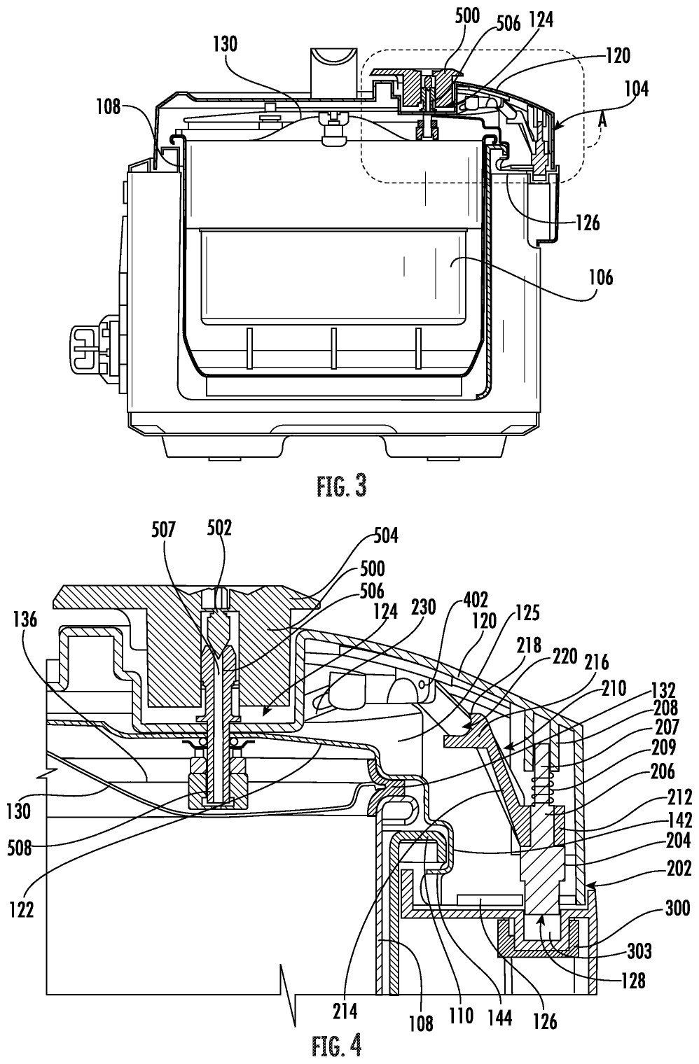

The base 102 includes various components conventionally found in pressure cookers, including a control dial 101, a heating element (not shown), a controller 600 connected between the control dial 101 and the heating element, and the like. Buttons or switches can be used in place of the control dial. A separate pot 108 (FIGS. 3 and 4) resides within the base 102. A solenoid 300 is mounted in the base 102 (see FIG. 4). The base 102 has one or more flanges 110 spaced about the periphery of the base 102 that are configured to interact with the lid 104. Together the base 102 and the lid 104 define an internal chamber 106 of the pressure cooker 100 (see FIG. 3),

For the purposes of describing the present invention, two additional axes are illustrated in FIG. 2. Line A-A defines the longitudinal axis of the pressure cooker 100, wherein the side of the pressure cooker 100 with the dial 101 defines the forward direction and the opposite side defines the rearward direction. Line B-B defines the lateral axis of the pressure cooker 100, wherein the side of the pressure cooker 100 shown at the top of FIG. 2 defines the leftward direction and the opposite side defines the rightward direction.

The lid 104 includes an outer cover 120 and an inner cover 122 that create a cavity 125. A recess 124 is present in the outer cover 120 to house the valve cover 500. A face cover 126 extends between the rear portion of the inner cover 122 and the rear edge of the outer cover 120. (see FIG. 4). A hole 128 is located in the rear portion of the face cover 126. A condensation plate 130 with a surrounding gasket 132 is attached to the underside of the inner cover 122 and is located to engage the upper edge of the pot 108. A plurality of vent holes (not visible in FIG. 4) are present in the condensation plate 130 to provide fluid communication between the internal chamber 106 and the space 136 between the condensation plate 130 and the inner lid 122.

As noted above, together the base 102 and the lid 104 define the internal chamber 106 of the pressure cooker 100 (see FIG. 3), with the gasket 132 sealing the lid 104 against the upper edge of the pot 108. The lid 104 is maintained in place via the interaction between the flanges 110 on the base 102 and a mating channel 142 in the inner lid 122. The lower panel 144 of the channel 142 is recessed at certain circumferential locations. In order to separate the lid 104 and the base 102 of the pressure cooker 100, the lid 104 is rotated relative to the base 102 to align the flanges 110 with the recesses in the lower panel 144, thereby allowing the lid 104 to be lifted from the base 102 (from the vantage point of FIG. 1, the lid 104 would be rotated about a vertical axis). Similarly, the lid 104 can be reattached by orienting the lid 104 so that the flanges 110 align with the recesses, then rotating the lid 104 relative to the base 102 to secure it into place.

Referring still to FIGS. 1 and 3, a vent sleeve 506 extends vertically through the inner lid 122 and outer lid 120 into the recess 124. The vent sleeve 506 defines an inner lumen 507 that is open to the space 136 via the lower end of the vent sleeve 506. The valve cover 500 includes a downwardly-extending stopper 502, and further includes a flange 504 extending radially outwardly from the top of the valve cover 500. In a closed resting position (shown in FIGS. 3 and 4), the top of the vent sleeve 506 is filled by the stopper 502 of the valve cover 500. In the illustrated embodiment, the valve cover 500 may be of sufficient weight that the stopper 502 seals the vent sleeve 506 when in the resting position. Magnetic or other force can also be applied to seat stopper 502 in vent sleeve 506.

As shown in FIGS. 4-7B, the lid 104 also comprises a pressure release mechanism, designated broadly at 200. The pressure release mechanism 200 comprises a vertical piston 202, a drive arm 210, a toggle member 220, and a lifting member 230. These components are described in greater detail below.

The vertical piston 202 may be approximately cylindrical in shape and comprises magnetized material, such that the vertical piston 202 will respond to a magnetic field. A seating flange 204 extends radially outwardly at a distance from the bottom end of the vertical piston 202. An engagement section 206 is located above the seating flange 204. The top section 207 of the vertical piston 202 is configured to rest within a hollow boss 208 with the lid 104 of the pressure cooker 100. In some embodiments, the radius of the top section 207 of the vertical piston 202 may be smaller than the engagement section 206, thereby forming a shoulder. The engagement section 206 is shown as being rectangular, but in additional embodiments may have a square, circular, triangular, or other cross-section. A biasing member 209 (such as a spring) may be included, such that the biasing member 209 engages with the top surface of the engagement section 206 and a bottom surface of the boss 208. The lower end of the piston 202 extends downwardly through the hole 128 in the face cover 126.

The drive arm 210 comprises a hollow region 212, which merges with an extension 214, which rises upwardly and forwardly from the hollow region 212 before merging with a platform 216. The inner surface of the hollow region 212 is configured to receive the engagement section 206 of the vertical piston 202. Furthermore, the bottom surface of the hollow region 212 is configured to engage the seating flange 204 of the vertical piston 202. The upper surface of the hollow region 212 engages the lower end of the spring 209. In some embodiments, the platform 216 is generally horizontal and may include two wings 218 extending upwardly from lateral sides of the platform 216.

In some embodiments, the lid 104 may include two ribs 143 extending downwardly from top of the lid 104 and defining a gap therebetween. The gap between the ribs 143 may include the hollow boss 208. The vertical piston 202 may extend between the two ribs 143, such that the engagement section 206 and the hollow region 212 of the drive arm 210 are located within the gap between the ribs 143. The hollow region 212 may include at least one radially outwardly extending flange 213 configured to potentially engage with a surface of at least one rib 143 to maintain the drive arm 210 in position laterally should it tend to drift.

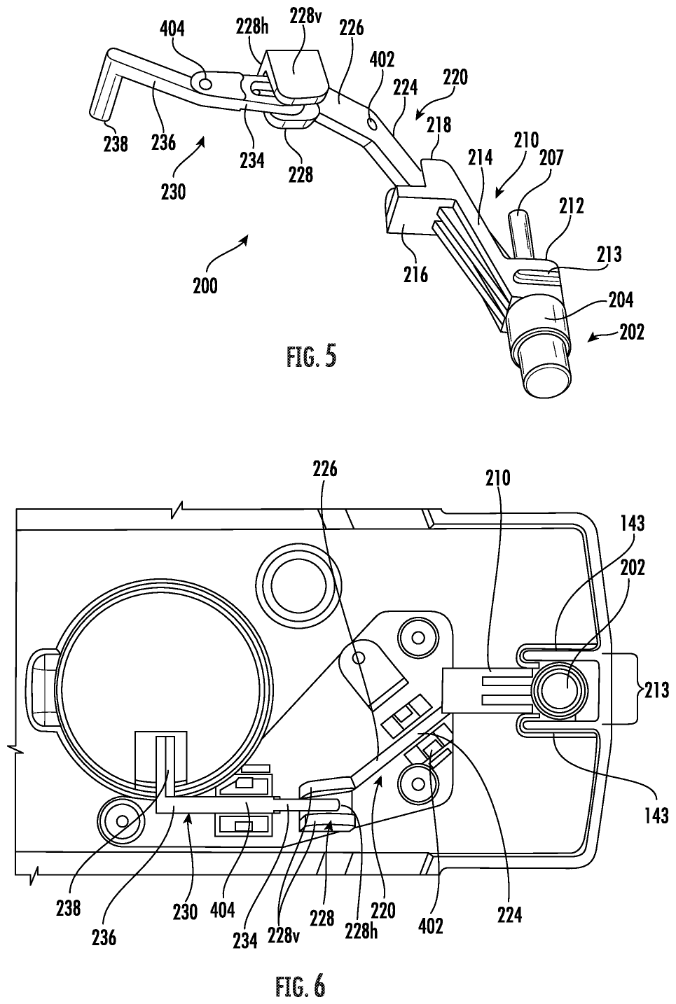

The toggle member 220 comprises a front segment 226 and a rear segment 224. The rear end of the rear segment 224 extends forwardly and upwardly from a position above and proximate to the platform 216 of the drive arm 210 before merging with the rear end of the front segment 226. In some embodiments, the rear end of the rear segment 224 extends between the wings 218 of the platform 216. As seen in FIG. 6, in some embodiments, the rear segment 224 also extends laterally away from the platform 216. The front segment 226 extends forwardly and downwardly from the rear segment 224. The toggle member 220 is pivotally connected to the lid 104 at a pivot 402 at the vertex of the front segment 226 and rear segment 224.

In the illustrated embodiment, the front end of the front segment 226 of the toggle member 220 includes a cage 228. The cage 228 comprises two vertical side walls 228v with a lateral extension 228h connecting the top end of each side wall 228v. In some embodiments, the profiles of the side walls 228v may be rectangles having arcuate bottom ends. In further embodiments, the side walls 228v may extend forwardly, but not laterally, from the front end of front segment 226.

The lifting member 230 comprises a front segment 236 and a rear segment 234. The rear end of the rear segment 234 extends forwardly from a position below and proximate to the lateral extension 228h of the cage 228 before merging with the rear end of the front segment 236. In some embodiments, the rear end of the rear segment 234 extends between the vertical walls 228v of the cage 228. The front segment 236 extends forwardly and upwardly from the rear segment 234. The lifting member 230 is pivotally attached to the lid 104 at a pivot 404 at the vertex of the front segment 236 and rear segment 234. The front segment 236 of the lifting member 230 includes a lifting finger 238. The lifting finger 238 extends below the valve cover 500.

The release mechanism 200 can be disposed in a resting position (see, e.g., FIGS. 3, 4 and 7A). Typically, when the lid 104 is attached to the base 102, the release mechanism 200 is in the resting position. The vertical piston 202 is positioned with the seating flange 204 resting on the face cover 126 and the lower portion of the piston 202 above and within a recess 303 in the solenoid 300 mounted on the base 102. Notably, the recess 303 and the remainder of the base 102 above the solenoid 300 provide watertight protection around the solenoid 300, particularly from moisture that might otherwise damage the solenoid 300.

As a result of the lowered position of the piston 202 in the recess 300, the drive arm 210 is in a lowered position. The lowered position of the platform 216 of the drive arm 210 allows the toggle member 220 to pivot about the pivot 402 so that the rear segment 224 is lowered and the front segment 226 is raised. The raised position of the front segment 226 (and the attached cage 228) in turn causes the rear segment 234 of the lifting member 230 to be raised. As such, the front segment 236 of the lifting member is pivoted to a lowered position, as is the lifting finger 238, which is positioned below the valve cover 500. Thus, the stopper 502 of the valve cover 500 is permitted to reside atop the upper vent sleeve 506, which seals the vent sleeve 506 from the outside, thereby preventing gas from the interior of the pressure cooker 100 from escaping during cooking. The weight of the valve cover 500 maintains the valve cover 500 in the lowered position.

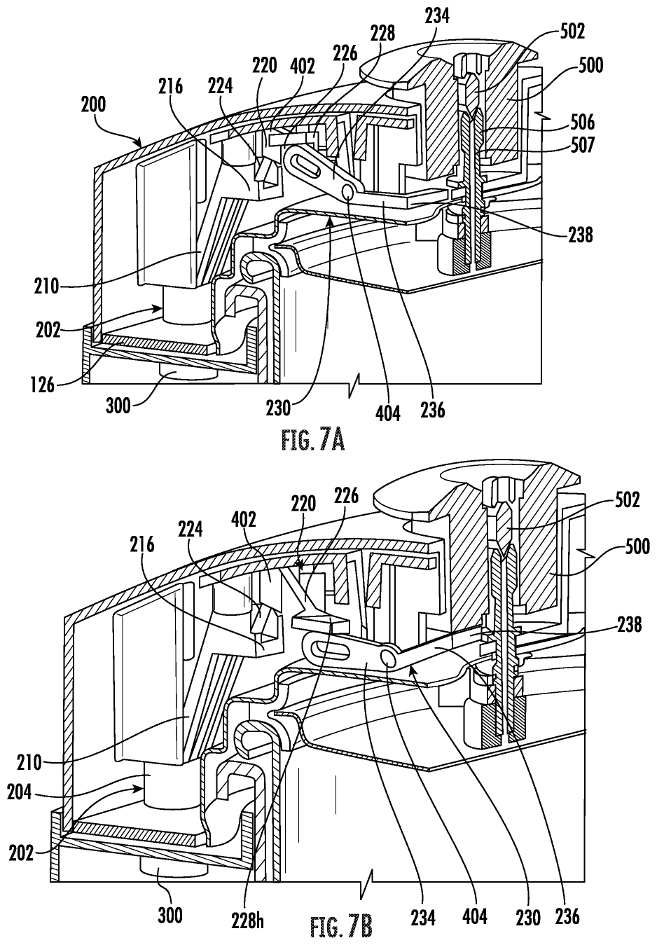

When the solenoid 300 is activated (FIG. 7B), it acts to repel the vertical piston 202, such that the vertical piston 202 rises to approach the top of the lid 104. The verticality of this action is maintained by the boss 208. As the hollow region 212 of the drive arm 210 engages both the engagement section 206 and the seating flange 204, the drive arm 210 also rises towards the top of the lid 104 (which compresses the spring 209 against the boss 208). As the drive arm 210 rises, the platform 216 contacts the rear segment 224 of the toggle member 220, forcing it upwardly. As the rear segment 224 rises, the toggle member 220 pivots about the hinge 402, such that the front segment 226 of the toggle member 220 moves downwardly.

As the front segment 226 moves downwardly, the lateral extension 228h of the cage 228 contacts the rear segment 234 of the lifting member 230, pushing the rear segment 234 downwardly. As the rear segment 234 moves downwardly, the lifting member 230 pivots about the hinge 404, such that the front segment 236 of the lifting member 230 moves upwardly. The lifting finger 238 then comes into contact with the bottom of the valve cover 500, causing the valve cover 500 to rise, which breaks the seal between the stopper 502 and the top of the vent sleeve 506, allowing the internal chamber 106 of the pressure cooker 100 to vent. Therefore, the activation of the solenoid 300 causes the pressure release mechanism 200 to move from the initial resting position of FIG. 7A to the release position, as illustrated in FIG. 7B.

After the solenoid 300 deactivates, the pressure release mechanism 200 returns to its initial resting position. In the absence of force being applied to the front segment 236 of the lifting member 230, the weight of the valve cover 500 can apply sufficient force to the front segment 236 of the lifting member 230 that the front segment 236 moves downwardly. As the front segment 236 moves downwardly, the lifting member 230 pivots about hinge 404, causing the rear segment 234 to move upwardly and contact the lateral extension 228h of the cage 228.

The force of the rear segment 234 of the lifting member 230 contacting the cage 228 of the front segment 226 of the toggle member 220 causes the front segment 226 to move upwardly. As the front segment 226 moves upwardly, the toggle member 220 pivots about the hinge 402, thereby causing the rear segment 224 to move downwardly and contact the platform 216 of the drive arm 210. While gravity may induce the drive arm 210 lower, compression in the spring 209 on the hollow region 212 of the drive arm 210 and on the engagement region 206 of the vertical piston 202 ensures that the drive arm 210 and vertical piston 202 are driven downwardly, such that the lower portion of the vertical piston 202 returns to the recess 303 in the base 102.

In embodiments in which the toggle member 220 extends laterally away from the platform 216 of the drive arm 210, the finger 238 may be positioned such that it is below only one side of the valve cover 500 (see FIGS. 7A and 7B), rather than the mechanism 200 being positioned beneath the center of the valve cover 500. Therefore, when the valve cover 500 is raised by the finger 238, there may be a higher likelihood that the valve cover 500 tilts sideways, rather than tilting straight forward, as compared to a setup wherein the mechanism 200 is positioned beneath the center of the valve cover 500. Thus, when steam is released through the vent sleeve 506, there may be a decreased likelihood that the steam will be ejected in the direction of a user standing in front of the pressure cooker 100.

The inclusion of the ribs 143, the wings 218 on the drive arm 210 and the inclusion of the cage 228 attached to toggle member 220 may allow the individual components of the pressure release mechanism 200 to retain their positions relative to each other while the lid 104 is being rotated or moved, even though these components are not attached to each other.

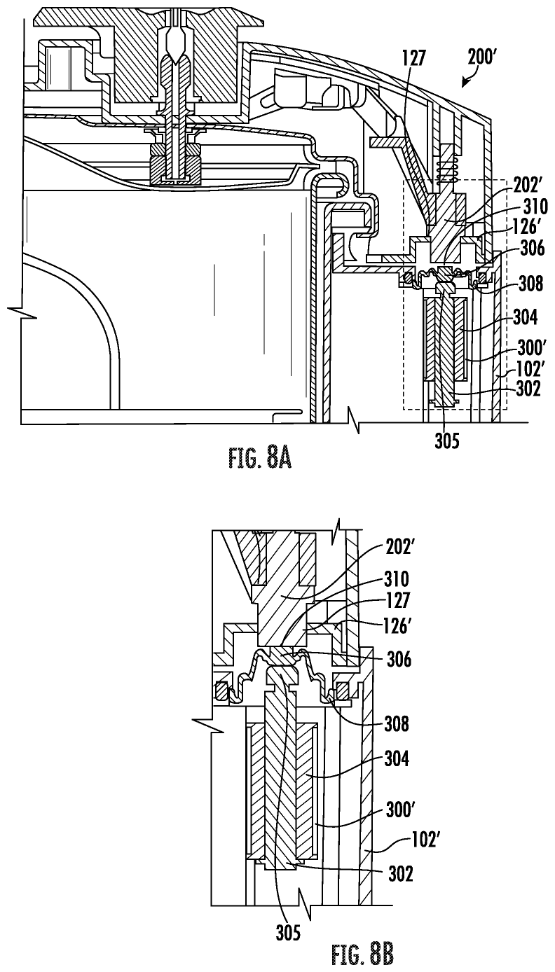

Referring now to FIGS. 8A and 8B, an alternative release mechanism 200′ is shown therein. The release mechanism 200′ has similar components as the release mechanism 200, but utilizes a different solenoid 300′. The solenoid 300′ has a sleeve 304 that surrounds a plunger 302. At its upper end, the plunger 304 has a head 305. A silicon stopper 308 is mounted in the base 102′ with a central plug 306 above the head 305 of the plunger 302. The upper surface 310 of the plug 306 is positioned below the piston 202′ of the release mechanism 200′. The face plate 126′ has a raised platform with a central hole 127 that receives the lower end of the piston 202′.

When the solenoid 300′ is energized, the plunger 302 rises within the sleeve 304 (see FIG. 8B). The head 305 of the plunger 302 contacts the plug 306 of the stopper 308, thereby forcing it upwardly and into the lower end of the piston 202′. Rising of the piston 202′ causes the remainder of the release mechanism 200′ to move as described above to release the valve cover 500. Deactivation of the solenoid 300′ causes the release mechanism 200′ to return to its resting state as described above.

Because it utilizes a plunger-style solenoid 300′, the release mechanism 200′ can employ a piston 202′ formed of plastic material that is non-magnetic, while still maintaining a sealed area around the solenoid 300′. In addition, it can be seen that, in the resting position shown in FIG. 8A, the piston 200′ does not extend downwardly into the base 102′. As a result, the lid can be removed from the base 102′ via rotation relative to the base 102′ as described above in connection with the base 102 while in the resting position (i.e., without needing to be elevated toward the release position). In contrast, the piston 202 discussed in connection with FIGS. 1-7 may require upward movement toward the release position in order to allow the lid 104 to rotate relative to the base 102.

In addition, the silicon stopper 308 also provides a watertight (or near watertight) seal between the solenoid 300′ and the release mechanism 200′. Such a seal can prevent potential damage to the solenoid 300′ due to moisture.

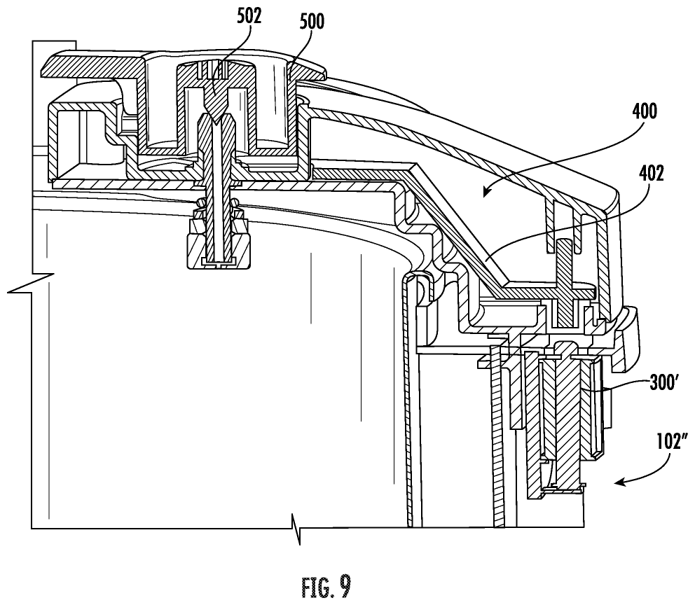

As illustrated in FIG. 9, alternative embodiments of the invention may include a pressure release mechanism 400 consisting of only a single member 402. When the solenoid 300′ in the base 102″ is activated, the single member 402 rises and contacts the valve cover 500, causing the valve cover 500 to rise and breaking the seal between the stopper 502 of the valve cover 500 and the vent sleeve 506.

The use of a purely mechanical mechanism 200, 200′, 400 for opening and closing the vent sleeve 506 may allow the pressure cooker 100 to operate without power being supplied directly to the lid 104. Accordingly, there is no electrical connection between the base 102 and lid 104. Using an unpowered lid 104 may allow the lid 104 and the base 102 of the pressure cooker 100 to be more easily separable and therefore provide additional convenience in addition to decreased power consumption costs for the user. In addition, those skilled in this art will appreciate that all of the members of the mechanical mechanisms 200, 200′, 400 are mounted/captured within the lid 104 and are detachable with the lid 104 when it is removed from the base 102.

The solenoid 300 is typically controlled by the controller, which energizes and de-energizes the solenoid 300 at specific instances. In some embodiments, the controller 600 may be configured to energize the solenoid 300 (and therefore release the pressure in the cooker 100) when cooking terminates, when a certain temperature level is reached after cooking, after a specified time period, or some combination of these. In some embodiments only one of these triggering events for pressure release may be employed, whereas in others the user may have the option of selecting between techniques; such selection may be performed via any number of selection components, such as dials (which may be integrated with or separate from the dial 101), buttons, knobs, a touchscreen, etc.

Also, in some embodiments the user may choose multiple pressure release techniques. For example, in some embodiments, the controller 600 can be configured to release pressure sometime after cooking has terminated (thus following the “natural release” technique discussed above for this time period), but before all of the pressure has dissipated (thus following the “quick release” technique for the second time period). The pressure release may be based on elapsed post-cooking time, temperature, pressure, another parameter, or customer preference (e.g., during a power loss). This capability can provide the user with considerable flexibility in post-cooking pressure release in order to optimize or improve the quality of the final cooked product.

Those of skill in this art will appreciate that the pressure release mechanism 200 may take other forms. For example, more or fewer members may be employed to convert the energy of the solenoid 300 on the piston 202 into a lifting force on the valve cover 500 (as an example, the piston 202 and the drive arm 210 may be combined into a single unit rather than being two separate pieces). The members of the release mechanism 200 may be linked via pivots, pins and slots, or the like, rather than relying on non-attached engagements. Guide features other than the boss 208 and ribs 143 may be employed. A force generator other than the solenoid 300 (for example, a compressed spring that is released to actuate the mechanism) may be employed. The valve cover 500 may be a valve having a different form, may be attached (e.g., via a traditional or living hinge) to the lid 104, and/or may require user manipulation to seal (e.g., the valve may require the user to press or rotate it into place in the vent sleeve 506). The vent sleeve 506 may be divided into a two-part sleeve that provides fluid communication between the chamber 106 and the external environment. Other variations may also be employed.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A pressure cooker, comprising:
a base configured to provide heat to a chamber for pressure cooking;
a lid that engages the base to seal the chamber;
a valve in the lid configured to selectively release pressure in the chamber through the lid;
a pressure release mechanism mounted to the lid and configured to engage the valve, the pressure release mechanism configured to move between resting and release positions, wherein in the resting position the valve remains in a sealed condition, and in the release position the pressure release mechanism engages the valve to unseal the valve from the lid to enable pressure in the chamber to be released through the lid; and
a solenoid operatively associated with the pressure release mechanism to move the pressure release mechanism from the resting position to the release position.

2. The pressure cooker defined in claim 1, wherein the pressure release mechanism comprise a plurality of members, wherein the lid is detachable from the base, and wherein each of the plurality of members of the pressure release mechanism is captured within the lid such that all of the members of the pressure release mechanism are also detachable from the base when the lid is detached.

3. The pressure cooker defined in claim 2, wherein the solenoid is mounted to the base.

4. The pressure cooker defined in claim 3, wherein the base includes a controller, and wherein the solenoid is operatively connected with the controller.

5. The pressure cooker defined in claim 4, wherein the controller is configured to receive user input regarding when the pressure release mechanism moves from the resting position to the release position.

6. The pressure cooker defined in claim 5, wherein the controller is configured to permit a user to select a setting wherein the pressure release mechanism moves to the release position after cooking is complete but before pressure in the chamber is released naturally.

7. A pressure cooker, comprising:
a base configured to provide heat to a chamber for pressure cooking;
a lid that engages the base to seal the chamber;
a valve in the lid configured to selectively release pressure in the chamber through the lid;
a pressure release mechanism mounted to the lid and configured to engage the valve, the pressure release mechanism configured to move between resting and release positions, wherein in the resting position the valve remains in a sealed condition, and in the release position the pressure release mechanism engages the valve to unseal the valve from the lid to enable pressure in the chamber to be released through the lid;
wherein the pressure release mechanism includes a lifting member residing within the lid, the lifting member including a lifting finger that engages the valve to unseal the valve as the pressure release mechanism moves from the resting position to the release position; and
a force generator operatively associated with the pressure release mechanism to move the pressure release mechanism from the resting position to the release position.

8. The pressure cooker defined in claim 7, wherein the lifting member is pivotally attached to the lid.

9. The pressure cooker defined in claim 8, wherein the pressure release mechanism further includes a toggle member pivotally attached to the lid, the toggle member engaging the lifting member.

10. The pressure cooker defined in claim 9, wherein the pressure release mechanism further comprises a piston, the piston operatively associated with the force generator, and operatively connected with the toggle member, the piston configured to move vertically actuated by the force generator.

11. The pressure cooker defined in claim 10, further comprising a drive arm that engages and moves with the piston.

12. The pressure cooker defined in claim 10, wherein the lid includes guide features that guide the vertical movement of the piston.

13. The pressure cooker defined in claim 10, wherein the lid is detachable from the base, and wherein each of the lifting member, toggle member and piston of the pressure release mechanism is captured within the lid such that the lifting member, toggle member and piston are also detachable from the base when the lid is detached.

14. The pressure cooker defined in claim 8, wherein the pivotal attachment of the lifting member defines generally a transverse axis, and wherein the lifting finger extends generally along the transverse axis, such that the valve releases pressure transversely when released.

15. A pressure cooker, comprising:
a base configured to provide heat to a chamber for pressure cooking;
a lid that engages the base to seal the chamber;
a valve in the lid configured to selectively release pressure in the chamber through the lid;
a pressure release mechanism mounted to the lid and configured to engage the valve, the pressure release mechanism configured to move between resting and release positions, wherein in the resting position the valve remains in a sealed condition, and in the release position the pressure release mechanism engages the valve to unseal the valve from the lid to enable pressure in the chamber to be released through the lid;
wherein the pressure release mechanism includes:
a lifting member pivotally attached to the lid, the lifting member including a lifting finger that engages the valve to unseal the valve;
a toggle member pivotally attached to the lid and engaging the lifting member; and
a piston operatively connected with the toggle member; and
a force generator operatively associated with the piston to move the piston upwardly to move the pressure release mechanism from the resting position to the release position.

16. The pressure cooker defined in claim 15, wherein the force generator is a solenoid.

17. The pressure cooker defined in claim 15, further comprising a drive arm that engages and moves with the piston.

18. The pressure cooker defined in claim 15, wherein the lid includes guide features that guide the vertical movement of the piston.

19. The pressure cooker defined in claim 15, wherein the lid is detachable from the base, and wherein each of the lifting member, toggle member and piston of the pressure release mechanism is captured within the lid such that the lifting member, toggle member and piston are also detachable from the base when the lid is detached.

20. The pressure cooker defined in claim 15, wherein the pivotal attachment of the lifting member defines generally a transverse axis, and wherein the lifting finger extends generally along the transverse axis, such that the valve releases pressure transversely when released.
